(19) United States
(12) Patent Application Publication
(10) Pub. No.: US 2026/0057308 A1
(43) Pub. Date: Feb. 26, 2026

(54) MULTI-AGENT-BASED INFORMATION PROCESSING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Mingjin Li, Beijing (CN); Xiang Ye, Beijing (CN); Chongling Li, Beijing (CN); Aixin Zhang, Beijing (CN)

(73) Assignee: BEIJING BAIDU NETCOM SCIENCE TECHNOLOGY CO., LTD., Beijing (CN)

(21) Appl. No.: 19/377,979

(22) Filed: Nov. 3, 2025

(30) Foreign Application Priority Data
Nov. 8, 2024 (CN) 202411595524.X

(51) Int. Cl. G06N 20/00; G06F 16/3329; G06F 16/335; G06F 18/21; G06F 18/214; G06F 40/30

(52) U.S. Cl. CPC G06N 20/00; G06F 16/33295; G06F 16/335; G06F 18/2148; G06F 18/217; G06F 40/30

(57) ABSTRACT

A multi-agent-based information processing method includes: receiving an information processing request, in which the information processing request includes input information; inputting the input information to a first agent and obtaining output information of the first agent, in which the first agent determines one or more second agents from a set of agents based on the input information; and obtaining response information corresponding to the input information based on the output information of the first agent and the one or more second agents.

### C-REFERENCE TO RELATED APPLICATIONS

The present application is based on and claims the priority of Chinese patent application No. 202411595524X filed on Nov. 8, 2024, the entire contents of which are incorporated herein by reference.

### TECHNICAL FIELD

The disclosure relates to the field of artificial intelligence (AI) technology, in particular to a multi-agent-based information processing method, an apparatus and an electronic device.

### BACKGROUND

Currently, in the process of using an agent as an intelligent customer service to converse with users, traditional agents lack an in-depth understanding of multi-turn dialogues and context, resulting in an inability to accurately grasp the user's true intents. Furthermore, traditional agents cannot provide personalized responses based on information such as the user's historical dialogues and profile, leading to a poor user experience.

### SUMMARY

The disclosure provides a multi-agent-based information processing method, an apparatus and an electronic device.

According to a first aspect of the disclosure, a multi-agent-based information processing method is provided. The method includes: receiving an information processing request, in which the information processing request includes input information; inputting the input information to a first agent and obtaining output information of the first agent, in which the first agent determines one or more second agents from a set of agents based on the input information; and obtaining response information corresponding to the input information based on the output information of the first agent and the one or more second agents.

According to a second aspect of the disclosure, an electronic device is provided. The electronic device includes: at least one processor and a memory communicatively connected to the at least one processor. The memory stores instructions executable by the at least one processor, and the instructions, when executed by the at least one processor, cause the at least one processor to implement the multi-agent-based information processing method in the embodiments of the first aspect.

According to a third aspect of the disclosure, a non-transitory computer-readable storage medium is provided. The medium stores computer instructions, and the computer instructions are used to cause a computer to implement the multi-agent-based information processing method in the embodiments of the first aspect.

It should be understood that the content described in this section is not intended to identify key or important features of the embodiments of the disclosure, nor is it intended to limit the scope of the disclosure. Additional features of the disclosure will be easily understood from the following descriptions.

### BRIEF DESCRIPTION OF THE DRAWINGS

The accompanying drawings are used to better understand this solution and do not constitute a limitation to the disclosure, in which:

FIG. 1 is a schematic flowchart of a multi-agent-based information processing method provided by an embodiment of the disclosure.

FIG. 2 is a schematic flowchart of the multi-agent-based information processing method provided by an embodiment of the disclosure.

FIG. 3 is a schematic flowchart of the multi-agent-based information processing method provided by an embodiment of the disclosure.

FIG. 4 is a schematic flowchart of the multi-agent-based information processing method provided by an embodiment of the disclosure.

FIG. 5 is a schematic flowchart of the multi-agent-based information processing method provided by an embodiment of the disclosure.

FIG. 6 is a schematic structural diagram of the multi-agent-based information processing method provided by an embodiment of the disclosure.

FIG. 7 is a schematic structural diagram of a multi-agent-based information processing apparatus provided by an embodiment of the disclosure.

FIG. 8 is a block diagram of an electronic device used to implement the multi-agent-based information processing method provided by the embodiments of the disclosure.

### DETAILED DESCRIPTION

The following descriptions of example embodiments of the disclosure are provided in combination with the accompanying drawings, which include various details of the embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following descriptions.

A multi-agent-based information processing method, an apparatus and an electronic device according to the embodiments of the disclosure are described below with reference to the accompanying drawings.

AI is a field of study of enabling computers to simulate certain human thought processes and intelligent behaviors, such as learning, reasoning, thinking and planning. It encompasses both hardware-level and software-level technologies. AI hardware technologies generally include computer vision, speech recognition, natural language processing, machine learning/deep learning, big data processing, and knowledge graph technologies.

An agent is a computer system or entity capable of autonomous action, environmental perception, decision-making, and interaction with its surroundings. The agent is a human-made system or machine that can perform tasks typically requiring human intelligence, such as visual recognition, language comprehension, decision-making and translation. The agent typically relies on a large language model as its core decision-making and processing unit, and possesses the ability to think independently and invoke tools to progressively achieve given objectives.

The multi-agent-based information processing method provided in the disclosure is applicable across multiple industry scenarios, including E-commerce platforms, financial institutions, medical consultation and educational tutoring. It provides users with interactive experiences characterized by low configuration costs, controllable logic, high accuracy and personalized customization.

The multi-agent-based information processing method of the disclosure is applicable to online platforms requiring large-scale user services, customer-facing enterprise services, and other scenarios demanding intelligent, highly automated customer service systems. Through multi-agent collaboration, the disclosure enables better alignment with service requirements, enhances user conversion rates, customer satisfaction and service efficiency, while reducing the need for human intervention.

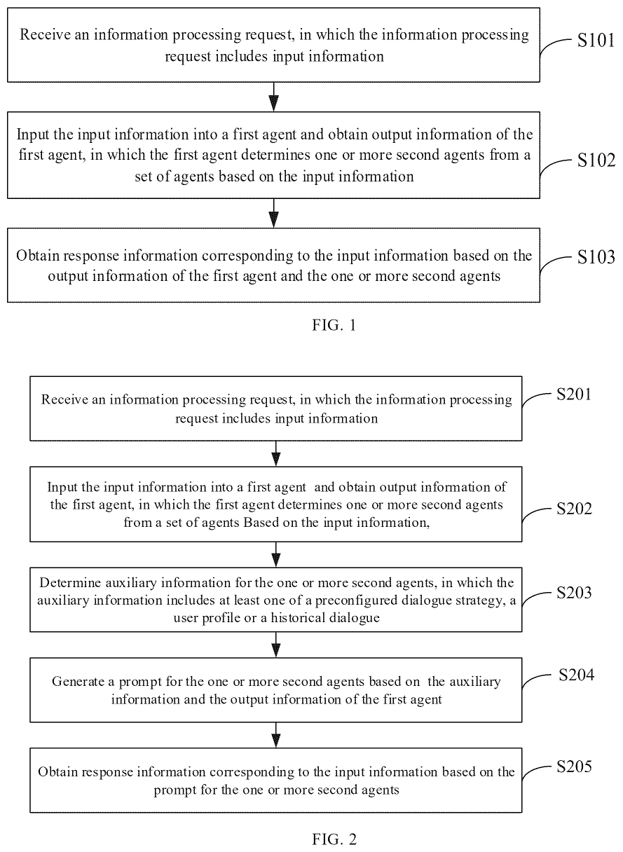

FIG. 1 is a schematic flowchart of a multi-agent-based information processing method provided by an embodiment of the disclosure.

As illustrated in FIG. 1, the multi-agent-based information processing method includes the following steps.

At step S101, an information processing request is received, in which the information processing request includes input information.

It should be noted that an execution entity of the multi-agent-based information processing method in the embodiment of the disclosure may be a hardware device with data processing capabilities and/or a necessary software to drive the hardware device to operate. The execution entity may include a server, a user terminal and other smart devices. The user terminal may include, but is not limited to, a mobile phone, a computer, a smart voice interaction devices, etc. The server may include, but is not limited to, a web server, an application server, a server within a distributed system, or a server combined with a block-chain, which is not limited by the embodiments of the disclosure.

In some implementations, the information processing request is generated based on user's input information. That is, after obtaining the user's input information, the information processing request is generated based on the input information. Or, a query statement entered by the user may be used as the input information.

The user's input information may be obtained from a data center of an agent.

At step S102, the input information is input into a first agent for the first agent to determine one or more second agents from a set of agents based on the input information, and output information of the first agent is obtained.

In some implementations, after inputting the input information into the first agent, the first agent processes the input information to obtain a user intent, and then determines the one or more second agents by planning among the agents in the set of agents based on the user intent. Here, the first agent may be a global planning agent.

The input information may be classified to determine the type of intent corresponding to the input information, as a user intent. Optionally, a predefined matching rule may be used to match the input information to determine the user intent. A pre-trained large model may also be used to identify the user intent based on the input information.

In some implementations, upon receiving the input information, the first agent generates an agent planning condition and standard operating procedure (SOP) workflow information, and uses the input information, the agent planning condition and the SOP workflow information as the output information. Then, the second agent can reply to the output information.

Upon receiving the input information, the first agent may determine whether an adjustment to the input information is necessary. If an adjustment is required, the adjusted input information is included as one item within the output information. If no adjustment is needed, the input information is included as one item within the output information. Optionally, the input information's format and/or content may be used to determine whether an adjustment to the input information is necessary.

The set of agents includes, but is not limited to, a script generation agent, a retrieval-augmented generation agent, an active dialogue agent, a dialogue-to-image generation agent, a dialogue-to-video generation agent, an image recognition agent and an information search agent.

It is understandable that the script generation agent is used to generate dialogue script and can employ a large language model (LLM) with parameters ranging from tens of billions to hundreds of billions as the script generation agent.

The retrieval-augmented generation agent is responsible for performing vector retrieval and recall from a data center (storing semi-structured and structured data) based on the input information, and generating responses, clarifications or refusals. The vector retrieval may adopt any retrieval-augmented generation (RAG) system. The definitions of responses, clarifications and refusals may be configured and defined using natural language, typically employing an LLM with parameters of 10 billion or fewer.

The proactive dialogue agent is used to generate proactive dialogue scripts based on information such as the user's historical dialogues or a user's profile when the user is silent. It typically employs an LLM with parameters ranging from tens of billions to hundreds of billions.

The dialogue-to-image generation agent can convert textual descriptions into images using AI technology. That is, the agent comprehends semantic information within a text and then generates a corresponding image according to such information.

The dialogue-to-video generation agent can convert textual descriptions into a dynamic video using AI technology. The agent must not only comprehend semantic information within a text but also understand movements and interactions of objects within the three-dimensional space to generate video information.

The image recognition agent is an intelligent system capable of autonomously perceiving image information, performing image analysis and recognition, and making decisions or executing related tasks based on the information. It utilizes advanced image recognition technologies, such as convolutional neural networks, to perform feature extraction, classification, and recognition on input images.

The information search agent is an intelligent system capable of autonomously searching, filtering and integrating information from the Internet, and providing corresponding information services based on user requirements. It utilizes advanced search engine technologies, natural language processing technologies and data mining technologies to achieve quick and precise matching of online information.

For example, if the input information is “describing an item A,” the first agent identifies the input information and determines the script generation agent as the second agent, to generate an introduction for the item A. If the input information is “describing an item A in an X style”, the first agent identifies the input information and determines the script generation agent and the RAG agent as the second agents, to generate an introduction for the item A in the X style.

At step S103, response information corresponding to the input information is obtained based on the output information of the first agent and the one or more second agents.

In some implementations, a prompt for the second agent is generated based on the output information of the first agent. The second agent then uses the prompt to response to the input information. Therefore, the response information corresponding to the input information is obtained. By inputting the prompt into the second agent, the response information can be obtained.

Optionally, auxiliary information of the second agent may be obtain to determine the prompt for the second agent by combining the auxiliary information and the output information. That is, the auxiliary information and the output information may be used as the prompt for the second agent.

The auxiliary information of the second agent may be obtained from a configuration center of agents. The auxiliary information includes, but is not limited to, a preconfigured dialogue strategy, a user profile or a historical dialogue.

In some implementations, when there are a plurality of second agents, an upstream-downstream relationship between the second agents is determined. The output information of the upstream agent serves as the prompt for the downstream agent, so that the second agent can determine its response information based on the input information.

According to the multi-agent-based information processing method provided by the embodiment of the disclosure, obtaining the information processing request including the input information and the output information of the first agent are obtained, and the one or more second agents are determined based on the input information by the first agent. Then, the second agent determines response information corresponding to the input information based on the output information. This enhances the efficiency and accuracy of the agent's response to the input information, improves a problem-solving efficiency and recall rates. By responding through multiple agents, it effectively increases the number of interactions between users and agents, as well as the effectiveness of conversations.

FIG. 2 is a schematic flowchart of the multi-agent-based information processing method provided by an embodiment of the disclosure.

As illustrated in FIG. 2, the multi-agent-based information processing method includes the following steps.

At step S201, an information processing request is received, in which the information processing request includes input information.

Details regarding step S201 may refer to the above embodiment, which will not be repeated herein.

At step S202, the input information is input into a first agent and output information of the first agent is obtained, in which the first agent determines one or more second agents from a set of agents based on the input information.

In some implementations, a user intent may be determined based on the input information. Based on the user intent, one or more agents are determined to insure personalized, differentiated agent responses, thereby delivering emotionally valuable response information.

In some implementations, intent recognition may be performed on the input information based on auxiliary information of the first agent to determine the user intent. Optionally, a user profile and historical behavior data may be obtained from a data center of agents as the auxiliary information of the first agent.

The first agent performs intent recognition on the input information based on the auxiliary information and obtains a set of intent information that includes at least one user intent, and determines one or more second agents from the set of agents based on the user intent.

In some implementations, before determining the one or more second agents, a corresponding set of agents may first be determined based on a current service scenario. This enables the determination of one or more second agents from the set of agents, thereby filtering out the set of agents that best matches the service requirements. This approach helps ensure that the selected second agent precisely meets the service requirements. A current target service scenario may be determined based on the input information. Agents associated with the target service scenario are obtained. A set of agents corresponding to the target service scenario may be determined based on the agent associated with the target service scenario. An association relationship between service scenarios and agents may be pre-established, so that after determining the target service scenario, the agents associated with the service scenario are determined by querying the association relationship.

In some implementations, a set of agents corresponding to different industries may be determined based on an industry field to which an agent belongs and an industry field of a user, to provide automated and intelligent interactions, which enhances service efficiency across various industry fields. After an industry field of an intelligent service and the industry field of the user corresponding to the input information are determined, the set of agents is obtained based on the industry field of the intelligent service and the industry field of the user corresponding to the input information.

The set of agents includes at least one of: a script generation agent, an RAG agent, a proactive dialogue agent, a dialogue-to-image generation agent, a dialogue-to-video generation agent, an image recognition agent or an information search agent.

At step S203, auxiliary information for the one or more second agents is determined, in which the auxiliary information includes at least one of a preconfigured dialogue strategy, a user profile or a historical dialogue.

In some embodiments of the disclosure, there is only one second agent, which may be a script generation agent, an RAG agent or a proactive dialogue agent.

In some implementations, to enhance the execution efficiency and accuracy of the second agent while optimizing user interaction experience, the auxiliary information of the second agent is determined, and the prompt is determined based on the auxiliary information.

In some embodiments, a target service corresponding to the second agent is determined, and configuration information of the target service corresponding to the second agent is obtained based on the target service. The auxiliary information of the second agent is obtained from the configuration information. For example, the configuration information is obtained from a configuration center, and the auxiliary information is determined from the configuration information. The auxiliary information includes at least one of a preconfigured dialogue strategy, a user profile or a historical dialogue.

In some embodiments, the configuration center includes a configuration information list containing configuration information corresponds to different target services. By querying the configuration information list based on the target service, the configuration information of the target service is obtained, and the auxiliary information is determined based on the configuration information.

At step S204, a prompt for the one or more second agents is generated based on the auxiliary information and the output information of the first agent.

In some embodiments, a prompt template may be pre-configured, and the auxiliary information and the output information of the first agent are input into the prompt template to generate the prompt for the second agent.

At step S205, response information corresponding to the input information is obtained based on the prompt for the one or more second agents.

In some implementations, after inputting the prompt input into the one or more second agents, the one or more second agents generates the response information corresponding to the input information based on the prompt. The response information corresponding to the input information may be generated based on a preset output format.

According to the multi-agent-based information processing method provided by the embodiment of the disclosure, after the information processing request containing the input information is received, the first agent first determines the user intent within the input information, determines the one or more second agents based on the user intent and then determines the output information. After the auxiliary information of the one or more second agents is obtained, the prompt of the one or more second agents is determined based on the auxiliary information and the output information. The one or more second agent then generate the response information corresponding to the input information based on the prompt. This enhances the efficiency and an accuracy of the agent's response to the input information, improves the problem-solving efficiency and recall rates. By responding through multiple agents, it effectively increases the number of interactions between users and agents, as well as the effectiveness of conversations.

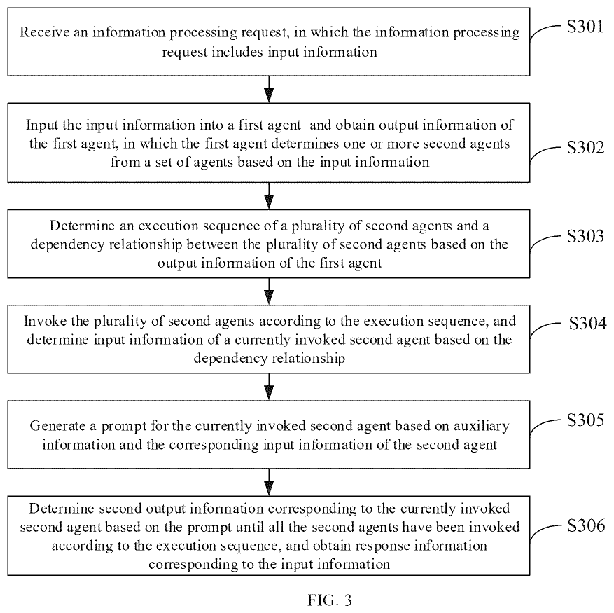

FIG. 3 is a schematic flowchart of the multi-agent-based information processing method provided by an embodiment of the disclosure.

As illustrated in FIG. 3, the multi-agent-based information processing method includes the following steps.

At step S301, an information processing request is received, in which the information processing request includes input information.

At step S302, the input information is input into a first agent and output information of the first agent is obtained, in which the first agent determines one or more second agents from a set of agents based on the input information.

Details regarding steps S301-S302 can refer to the above embodiment, which will not be repeated herein.

At step S303, an execution sequence of the second agents and a dependency relationship between the second agents are determined based on the output information of the first agent.

In some implementations, when there are a plurality of second agents, the execution sequence of the second agents and the dependency relationship between the second agents included in the output information are determined by parsing the output information of the first agent.

For example, the execution sequence of the second agents and the dependency relationship between the second agents are determined based on an agent planning condition and SOP workflow information included in the output information.

At step S304, the plurality of second agents are invoked according to the execution sequence, and input information of the currently invoked second agent is determined based on the dependency relationship.

In some implementations, an upstream-downstream relationship between the second agents is determined based on the dependency relationship. The output of the upstream agent serves as the input of the downstream agent, to optimize a workflow and enhance a collaboration efficiency of the system. That is, the upstream agent relied upon by the currently invoked second agent is determined based on the dependency relationship, and the upstream agent is at least one of the plurality of second agents.

The output information of the upstream agent is obtained and determined as the input information of the second agent currently invoked. For example, the second agents include a script generation agent and an RAG agent, the second agent currently invoked is the script generation agent, and its upstream agent is the RAG agent. That is, RAG is performed first, and then the output information of the RAG agent is used as the input information of the script generation agent.

At step S305, a prompt for the currently invoked second agent is generated based on auxiliary information and a corresponding input information of the second agent.

In some implementations, a prompt template may be pre-configured, and the auxiliary information and the corresponding input information of the second agent are input into the prompt template to generate the prompt for the currently invoked second agent.

At step S306, second output information corresponding to the currently invoked second agent is determined based on the prompt for the currently invoked second agent until all the second agents have been invoked according to the execution sequence, and the response information corresponding to the input information is obtained.

In some implementations, after inputting the prompt into the currently invoked second agent, the second agent generates the second output information based on the prompt, which is used as the input information of its downstream agent, and then generates a corresponding prompt for the downstream agent based on the input information. The downstream agent also generates corresponding output information based on the prompt, and continue this process until all the second agents have been invoked according to the execution sequence, and the output information of the last invoked second agent is determined as the response information corresponding to the input information.

According to the multi-agent-based information processing method provided by the embodiment of the disclosure, after the information processing request containing the input information is received, the first agent determines the one or more second agents, and the output information of the first agent is obtained based on the input information. After the execution sequence and the dependency relationship between the second agents are determined, the input information of the currently invoked second agent is determined based on the dependency relationship, and then the prompt for the second agent is determined based on the input information. Then, the second output information corresponding to the second agent currently invoked is determined based on the prompt. This process is continued until all the second agents have been invoked according to the execution sequence to obtain the response information corresponding to the input information. This enhances the efficiency and accuracy of the agent's response to the input information, improves the problem-solving efficiency and recall rates. By responding through multiple agents, it effectively increases the number of interactions between users and agents, as well as the effectiveness of conversations.

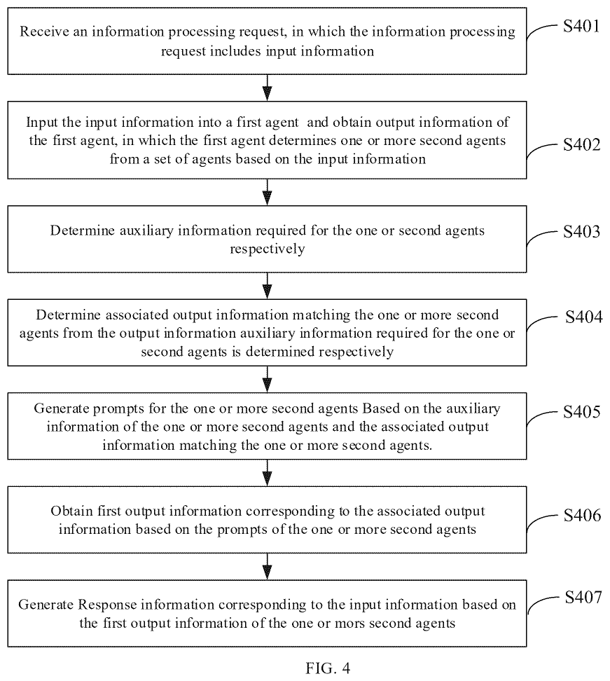

FIG. 4 is a schematic flowchart of the multi-agent-based information processing method provided by an embodiment of the disclosure.

As illustrated in FIG. 4, the multi-agent-based information processing method includes the following steps.

At step S401, an information processing request is received, in which the information processing request includes input information.

At step S402, the input information is input into a first agent and output information of the first agent is obtained, in which the first agent determines one or more second agents from a set of agents based on the input information.

Details regarding steps S401-S402 can refer to the above embodiment, which will not be repeated herein.

At step S403, auxiliary information required for the one or second agents is determined respectively.

In some implementations, the auxiliary information of each second agent is obtained from configuration information by determining the respective target services of each second agent and determining the configuration information corresponding to the target operations. For example, the configuration information is obtained from a configuration center based on the target service, and the auxiliary information is determined based on the configuration information.

At step S404, associated output information matching the one or more second agents is determined respectively from the output information.

In some implementations, the associated output information matching the second agent is obtained after filtering the output information. The associated output information matching the second agent may be obtained by filtering the output information based on characteristic information of the second agent, such as characteristics, requirements and functions.

At step S405, prompts for the one or more second agents are generated based on the auxiliary information of the one or more second agents and the associated output information matching the one or more second agents.

In some implementations, for each second agent, the prompt may be determined based on a pre-configured prompt template. The prompt for each second agent is generated by inputting the auxiliary information of the second agent and the matching associated output information into the prompt template.

At step S406, first output information corresponding to the associated output information is obtained based on the prompts of the one or more second agents.

At step S407, response information corresponding to the input information is generated based on the first output information of the one or more second agents.

In some implementations, after inputting a prompt into a second agent, the second agent generates first output information corresponding to the input information based on the prompt. The response information corresponding to the input information is obtained by combining the first output information of each second agent.

In some implementations, the first output information of each second agent may also be used as the response information, which means that a single piece of input information may correspond to multiple response information.

According to the multi-agent-based information processing method provided by the embodiment of the disclosure, after the information processing request containing the input information is received, the first agent determines the one or more second agents, and the output information of the first agent is obtained based on the input information. The auxiliary information of each second agent is determined, and the associated output information matching the second agent is determined from the output information to determine the prompt of the second agent. Then, the second agent determines the response information corresponding to the input information based on the prompt. This enhances the efficiency and accuracy of the agent's replies to the input information, improves a problem-solving efficiency and recall rates. By responding through multiple agents, it effectively increases the number of interactions between users and agents, as well as the effectiveness of conversations.

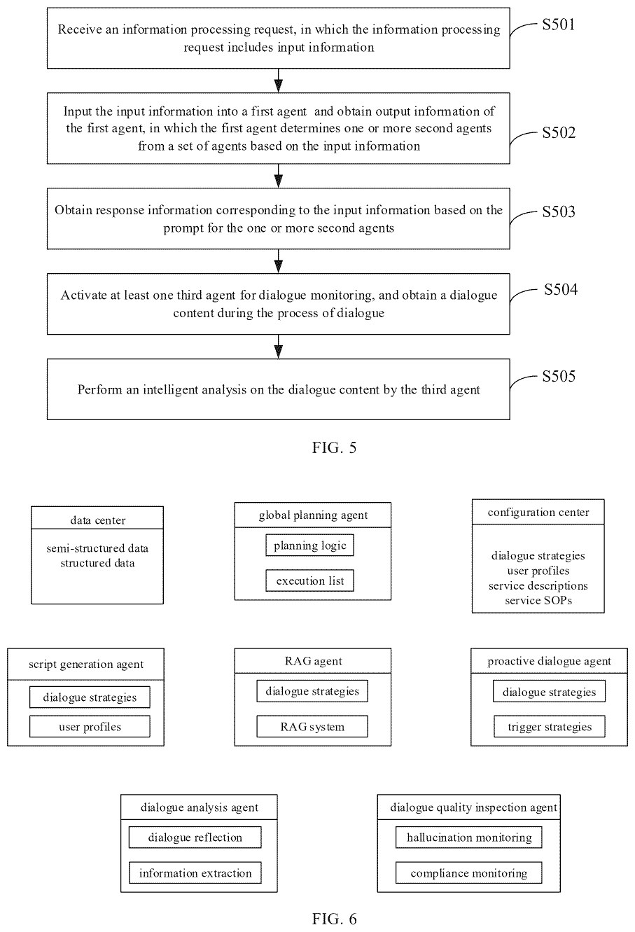

FIG. 5 is a schematic flowchart of the multi-agent-based information processing method provided by an embodiment of the disclosure.

As illustrated in FIG. 5, the multi-agent-based information processing method includes the following steps.

At step S501, an information processing request is received, in which the information processing request includes input information.

At step S502, the input information is input into a first agent and output information of the first agent is obtained, in which the first agent determines one or more second agents from a set of agents based on the input information.

At step S503, response information corresponding to the input information is obtained based on the output information of the first agent and the one or more second agents.

Details regarding steps S501-S503 can refer to the above embodiment, which will not be repeated herein.

At step S504, at least one third agent for dialogue monitoring is activated, and a dialogue content during the process of dialogue is obtained.

In some embodiments, the third agent includes a dialogue analysis agent and a dialogue quality inspection agent. By activating the third agent and acquiring a dialogue content from a user's dialogue with the second agent, the third agent may analyze the dialogue content to promptly identify issues encountered by the user during the conversation. It can then respond and resolve these issues quickly, thereby enhancing user satisfaction. Moreover, the agent is optimized based on an analysis result, which improves its learning capability.

At step S505, intelligent analysis for the dialogue content is performed by the third agent.

In some implementations, if the third agent is a dialogue analysis agent, it performs an information extraction on the dialogue content to obtain key information, which is used to optimize subsequent dialogues. The third agent may also be used to clarify and reflect on the dialogue content to obtain a dialogue reflection result, which is used to optimize the agents. Therefore, a learning capability and an adaptability of the agents are improved.

In some embodiments, the key information and the dialogue reflection result are determined as an analysis result of the dialogue analysis agent, and first structured data is obtained by performing structural processing on the analysis result of the dialogue analysis agent. The first structured data is determined as shared data and stored in a data center. Moreover, the first structured data is accessible by at least one of the first agent or the one or more second agents.

That is, the first agent and the second agent may optimize themselves by accessing the structured data in the data center, thereby enhancing their learning capabilities and adaptability.

In some implementations, if the third agent is a dialogue quality inspection agent, it obtains a quality inspection result by performing a hallucination monitoring and compliance monitoring on the dialogue content, and performs a fine-tuning training on the agent based on the quality inspection result to correct its errors and hallucinations, thereby improving the accuracy of its response.

In some embodiments, an abnormal dialogue content may be determined based on the quality inspection result, and the abnormal dialogue content are collected as sample data for an agent fine-tuning. The sample data is used to a fine-tuning training of a relevant agent to obtain a fine-tuned agent for subsequent dialogues.

According to the multi-agent-based information processing method provided by the embodiments of the disclosure, after the information processing request containing the input information is received, the first agent determines the one or more second agents, and the output information of the first agent is obtained based on the input information. The one or more second agent determine the response information corresponding to the input information based on the output information to enhance the efficiency and accuracy of the agent's responses to the input information. By responding through multiple agents, it effectively increases the number of interactions between users and agents. After the dialogue content is obtained, the third agent analyzes the dialogue content to promptly identify issues encountered by the user during the conversation and enables rapid response and resolution, which enhances user satisfaction. Moreover, the agent is optimized according to the analysis result, which improves its learning capability.

For example, taking a pre-sales scenario in a marketing field for customer acquisition and customer lead information collection as an example, an explanation of the multi-agent-based information processing method provided in the embodiment of the disclosure is explained below.

The first agent is a global planning agent, the second agent is a script generation agent, an RAG agent and a proactive dialogue agent, and the third agent is a dialogue analysis agent and a dialogue quality inspection agent.

By inputting the input information into the global planning agent, it determines that the second agent includes the script generation agent, the RAG agent and the proactive dialogue agent, and generates a planning strategy, a primary objective and a secondary objective as output information of the first agent. The planning strategy functions as a strategy planner for sales scenarios, the primary objective is customer acquisition, and the secondary objective involves obtaining detailed descriptions of customer lead information.

It is determines that the execution sequence of the second agents is: the script generation agent, the RAG agent and the proactive dialogue agent. A prompt for the script generation agent is determined based on its auxiliary information: pre-sales service role in sales scenarios, obtaining detailed descriptions of customer lead information, and providing a high-quality customer service interaction experience. By inputting the prompt into the script generation agent, its corresponding second output information is obtained, and a prompt for the RAG agent is generated based on the second output information: Q&A in sales scenarios. This prompt is input into the RAG agent to obtain corresponding second output information. Based on the second output information, a prompt for the proactive dialogue agent is generated: a personal assistant in private sales scenarios, reestablishing contact with users by combining historical dialogues.

After the dialogue content during interaction is obtained, the dialogue quality inspection agent and the dialogue analysis agent are used to analyze the dialogue content, and the agents are optimized based on the analysis result.

FIG. 6 is a schematic structural diagram of the multi-agent-based information processing method provided by an embodiment of the disclosure. FIG. 6 includes: a data center, a configuration center, and several agents, including a global planning agent, a script generation agent, an RAG agent, a proactive dialogue agent, a dialogue analysis agent and a dialogue quality inspection agent.

The data center stores semi-structured user data and structured user data, such as historical dialogues and dialogue content analysis results. The configuration center stores auxiliary information of agents, such as dialogue strategies, trigger strategies, user profiles, service descriptions, and service SOPs.

The global planning agent generates a planning logic and an execution list for one or more second agents based on user's input information as output information, and then invokes the one or more second agents. Taking the second agent as a script generation agent as an example, it obtains the dialogue strategy and the user profile from the configuration center as auxiliary information, and generates the prompt based on the auxiliary information and the output information of the global planning agent, and then determines the response information corresponding to the input information based on the prompt.

Taking the second agent as an RAG agent as an example, it obtains the dialogue strategy and an RAG system from the configuration center as auxiliary information, and generates a prompt based on the auxiliary information and the output information of the global planning agent, and then determines the response information corresponding to the input information based on the prompt.

Taking the second agent as a proactive dialogue agent as an example, it obtains the dialogue strategy and trigger strategy from the configuration center as auxiliary information, and generates a prompt based on the auxiliary information and the output information of the global planning agent, and then determines the response information corresponding to the input information based on the prompt.

During agent-based dialogues, at least one of the dialogue analysis agent or the dialogue quality inspection agent may be used to monitor and analyze the dialogue content. Taking the dialogue analysis agent as an example, it performs an information extraction on the dialogue content to obtain key information, which is used to optimize subsequent dialogues. It may also be used to clarify and reflect on the dialogue content to generate a dialogue reflection result.

Taking a dialogue quality inspection agent as an example, it performs a hallucination monitoring and compliance monitoring on a dialogue content to obtain a quality inspection result, and conducts a fine-tuning training on a relevant agent based on the result.

Corresponding to the multi-agent-based information processing method provided in the above embodiments, an embodiment of the disclosure provides a multi-agent-based information processing apparatus. Since the multi-agent-based information processing apparatus provided in the embodiment of the disclosure corresponds to the multi-agent-based information processing method provided in the above embodiments, the implementations of the multi-agent-based information processing method are also applicable to the multi-agent-based information processing apparatus provided in the embodiment of the disclosure, which will not be described in detail in the following embodiments.

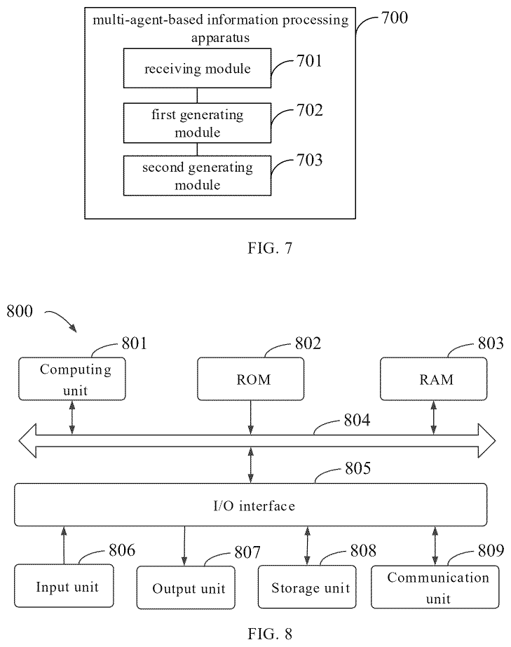

FIG. 7 is a schematic structural diagram of a multi-agent-based information processing apparatus provided by an embodiment of the disclosure.

As illustrated in FIG. 7, the multi-agent-based information processing apparatus 700 in the embodiment of the disclosure includes: a receiving module 701, a first generating module 702 and a second generating module 703.

The receiving module 701 is configured to receive an information processing request, in which the information processing request includes input information.

The first generating module 702 is configured to input the input information to a first agent and obtain output information of the first agent, in which the first agent determines one or more second agents from a set of agents based on the input information.

The second generating module 703 is configured to obtain response information corresponding to the input information based on the output information of the first agent and the one or more second agents.

In an embodiment of the disclosure, the second generating module 703 is further configured to: determine auxiliary information required for the one or more second agents, in which the auxiliary information includes at least one of a preconfigured dialogue strategy, a user profile or a historical dialogue; generate a prompt for the one or more second agents based on the auxiliary information and the output information of the first agent; and obtain the response information corresponding to the input information based on the prompt for the one or more second agents.

In an embodiment of the disclosure, the second generating module 703 is further configured to: determine an execution sequence of a plurality of second agents and a dependency relationship between the plurality of second agents based on the output information of the first agent; invoke the plurality of second agents according to the execution sequence, and determine input information of a currently invoked second agent based on the dependency relationship; generate a prompt for the currently invoked second agent based on auxiliary information and a corresponding input information of a second agent; and obtain second output information corresponding to the currently invoked second agent based on the prompt until all the second agents have been invoked according to the execution sequence, and obtain the response information corresponding to the input information.

In an embodiment of the disclosure, the second generating module 703 is further configured to: determine an upstream agent relied upon by the currently invoked second agent based on the dependency relationship, in which the upstream agent is at least one of the plurality of second agents; and determine output information of the upstream agent as the input information of the currently invoked second agent.

In an embodiment of the disclosure, the second generating module 703 is further configured to: determine auxiliary information required for the plurality of second agents respectively; determine associated output information matching the plurality of second agents respectively from the output information; generate prompt for the plurality of second agents based on the auxiliary information of the plurality of second agents and the associated output information matching the plurality of second agents respectively; obtain first output information corresponding to the associated output information based on the prompts for the plurality of second agents respectively; and generate the response information corresponding to the input information based on the first output information of the plurality of second agents.

In an embodiment of the disclosure, the apparatus further includes: an obtaining module, configured to activate at least one third agent for dialogue monitoring, and obtain a dialogue content during a process of dialogue; and an analyzing module, configured to perform an intelligent analysis on the dialogue content by the third agent.

In an embodiment of the disclosure, the analyzing module is further configured to: perform an information extraction on the dialogue content by the third agent to obtain key information, in which the key information is used to optimize subsequent dialogues; or perform an information clarification and reflection on the dialogue content by the third agent to obtain a dialogue reflection result.

In an embodiment of the disclosure, the analyzing module is further configured to: determine the key information and the dialogue reflection result as an analysis result of the dialogue analysis agent; obtain first structured data by performing structural processing on the analysis result of the dialogue analysis agent; and determine the first structured data as shared data and storing the shared data in a data center, in which the first structured data is accessible by at least one of the first agent or the one or more second agents.

In an embodiment of the disclosure, the analyzing module is further configured to: obtain a quality inspection result by performing a hallucination monitoring and a compliance monitoring on the dialogue content by the third agent.

In an embodiment of the disclosure, the analyzing module is further configured to: determine an abnormal dialogue content based on the quality inspection result, and collect the abnormal dialogue content as sample data for an agent fine-tuning, in which the sample data is used for a fine-tuning training of a relevant agent.

In an embodiment of the disclosure, the second generating module 703 is further configured to: obtain one or more target services corresponding to the one or more second agents; and obtain configuration information of the one or more target service corresponding to the one or more second agents, and obtain the auxiliary information required for the one or more second agents from the configuration information.

In an embodiment of the disclosure, the first generating module 702 is further configured to: obtain a user profile and historical behavior data as auxiliary information for the first agent; obtain a set of intent information by performing an intent recognition on the input information based on the auxiliary information for the first agent by the first agent, in which the set of intent information at least includes one user intent; and determine the one or more second agents from the set of agents based on the at least one user intent.

In an embodiment of the disclosure, the first generating module 702 is further configured to: determine a current target service scenario based on the input information; obtain an agent associated with the target service scenario; and determine the set of agents corresponding to the target service scenario according to the agent associated with the target service scenario.

In an embodiment of the disclosure, the first generating module 702 is further configured to: obtain an industry field to which an intelligent service belongs and an industry field of a user corresponding to the input information; and obtain the set of agents based on the industry field to which the intelligent service belongs and the industry field of the user corresponding to the input information.

In an embodiment of the disclosure, the set of agents includes at least one of: a script generation agent, an RAG agent, a proactive dialogue agent, a dialogue-to-image generation agent, a dialogue-to-video generation agent, an image recognition agent or an information search agent.

According to the multi-agent-based information processing apparatus provided by the embodiment of the disclosure, after obtaining the information processing request including the input information, the first agent determines the one or more second agents based on the input information, and the output information of the first agent is obtained. Then, the second agent determines its response information corresponding to the input information based on the output information. This enhances the efficiency and accuracy of the agent's response to the input information, improves the problem-solving efficiency and recall rates. By responding through multiple agents, it effectively increases the number of interactions between users and agents, as well as the effectiveness of conversations.

In the technical solutions of the disclosure, acquisition, storage and application of user personal information all comply with relevant laws and regulations and do not violate public order and good customs.

According to the embodiments of the disclosure, the disclosure also provides an electronic device, a readable storage medium and a computer program product.

FIG. 8 is a schematic block diagram of an example electronic device 800 that can be used to implement the embodiments of the disclosure. The electronic device is intended to represent various forms of digital computers, such as a laptop computer, a desktop computer, a workbench, a personal digital assistant, a server, a blade server, a mainframe computer and other appropriate computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementations of the disclosure described and/or required herein.

As illustrated in FIG. 8, the device 800 includes: a computing unit 801 for performing various appropriate actions and processes according to computer programs/instructions stored in a read-only memory (ROM) 802 or computer programs/instructions loaded from a storage unit 808 to a random access memory (RAM) 803. The RAM 803 may also stores necessary programs and data for the device 800 to operate. The computing unit 801, the ROM 802 and the RAM 803 are connected to each other through a bus 804. An input/output (I/O) interface 805 is also connected to the bus 804.

Components in the device 800 are connected to the I/O interface 805, including: an input unit 806, such as a keyboard and a mouse; an output unit 807, such as various types of displays and speakers; the storage unit 808, such as a disk and an optical disk; and a communication unit 809, such as a network card, a modem and a wireless communication transceiver. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of the computing unit 801 include, but are not limited to, a central processing unit (CPU), a graphics processing unit (GPU), various dedicated AI computing chips, various computing units that run machine learning model algorithms, a digital signal processor (DSP) and any appropriate processor, controller or microcontroller. The computing unit 801 executes the various methods and processes described above, such as the multi-agent information processing method. For example, in some embodiments, the above method may be implemented as a computer software program, which is tangibly contained in a machine readable medium, such as the storage unit 808. In some embodiments, part or all of the computer programs/instructions may be loaded and/or installed on the device 800 via the ROM 802 and/or the communication unit 809. When the computer programs/instructions are loaded on the RAM 803 and executed by the computing unit 801, one or more steps of the above method may be executed. Alternatively, in other embodiments, the computing unit 801 may be configured to perform the above method in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs/instructions, the one or more computer programs/instructions may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program code configured to implement the method of the disclosure may be written in any combination of one or more programming languages. These program codes may be provided to a processor/controller of a general-purpose computer, a dedicated computer or any other programmable data processing device, so that when the program code is executed by the processor/controller, the functions/operations specified in the flowchart and/or block diagram can be implemented. The program code may be executed entirely on the machine, partly executed on the machine, partly executed on the machine and partly executed on the remote machine as an independent software package, or entirely executed on the remote machine or a server.

In the context of the disclosure, a machine-readable medium may be a tangible medium that may contain or store programs for use by or in combination with an instruction execution system, an apparatus or a device. The machine-readable medium may be a machine-readable signal medium or a machine-readable storage medium. The machine-readable medium includes, but is not limited to, an electronic, magnetic, optical, electromagnetic, infrared, or semiconductor system/apparatus/device, or any suitable combination of the above. More specific examples of the machine-readable storage medium include electrical connections according to one or more wires, portable computer disks, hard disks, RAMs, ROMs, electrically programmable ROMs (EPROMs) or flash memories, fiber optics, compact disc-ROMs (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to the user, and a keyboard and a pointing device (such as a mouse or a trackball) through which the user can provide input to the computer. Other kinds of devices may also be used to provide interaction with the user. For example, feedback provided to the user may be any form of sensory feedback (e.g., visual feedback, auditory feedback or haptic feedback), and the input from the user may be received in any form (including acoustic input, voice input or tactile input).

The systems and technologies described herein may be implemented in a computing system that includes back-end components (for example, a data server), a computing system that includes middleware components (for example, an application server), a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication, such as a communication network. The communication network may include, for example, a local area network (LAN), a wide area network (WAN), the Internet and a block-chain network.

The computer system may include a client and a server. The client and the server are generally remote from each other and interacting through a communication network. The client-server relation is generated by computer programs/instructions running on the respective computers and having a client-server relation with each other. The server may be a cloud server, a server with a distributed system, or a server combined with a block-chain.

It is understandable that the above steps can be reordered, added or deleted using various forms of the processes shown above. For example, the steps in the disclosure may be performed in parallel, sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on design requirements and other factors. Any modifications, equivalent substitutions and improvements made within the spirit and principles of the disclosure shall be included in the scope of protection of the disclosure.

What is claimed is:

1. A multi-agent-based information processing method, comprising:
receiving an information processing request, wherein the information processing request comprises input information;
inputting the input information to a first agent and obtaining output information of the first agent, wherein the first agent determines one or more second agents from a set of agents based on the input information; and
obtaining response information corresponding to the input information based on the output information of the first agent and the one or more second agents.

2. The method of claim 1, wherein obtaining the response information corresponding to the input information based on the output information of the first agent and the one or more second agents comprises:
determining auxiliary information required for the one or more second agents, wherein the auxiliary information comprises at least one of a preconfigured dialogue strategy, a user profile or a historical dialogue;
generating a prompt for the one or more second agents based on the auxiliary information and the output information of the first agent; and
obtaining the response information corresponding to the input information based on the prompt for the one or more second agents.

3. The method of claim 1, wherein the one or more second agents comprise a plurality of second agents, obtaining the response information corresponding to the input information based on the output information of the first agent and the one or more second agents comprises:
determining an execution sequence of the plurality of second agents and a dependency relationship between the plurality of second agents based on the output information of the first agent;
invoking the plurality of second agents according to the execution sequence, and determining input information of a currently invoked second agent based on the dependency relationship;
generating a prompt for the currently invoked second agent based on auxiliary information and a corresponding input information of a second agent; and
obtaining second output information corresponding to the currently invoked second agent based on the prompt for the currently invoked second agent until all the second agents have been invoked according to the execution sequence, and obtaining the response information corresponding to the input information.

4. The method of claim 3, wherein determining the input information of the currently invoked second agent based on the dependency relationship comprises:
determining an upstream agent relied upon by the currently invoked second agent based on the dependency relationship, wherein the upstream agent is at least one of the plurality of second agents; and
determining output information of the upstream agent as the input information of the currently invoked second agent.

5. The method of claim 1, wherein the one or more second agents comprise a plurality of second agents, obtaining the response information corresponding to the input information based on the output information of the first agent and the one or more second agents comprises:
determining auxiliary information required for the plurality of second agents respectively;
determining associated output information matching the plurality of second agents respectively from the output information;
generating prompts for the plurality of second agents based on the auxiliary information of the plurality of second agents and the associated output information matching the plurality of second agents respectively;
obtaining first output information corresponding to the associated output information based on the prompts for the plurality of the second agents respectively; and
generating the response information corresponding to the input information based on the first output information of the plurality of second agents.

6. The method of claim 2, further comprising:
activating at least one third agent for dialogue monitoring, and obtaining a dialogue content during a process of dialogue; and
performing an intelligent analysis on the dialogue content by the third agent.

7. The method of claim 6, wherein the third agent is a dialogue analysis agent, and performing the intelligent analysis on the dialogue content by the third agent comprises:
performing an information extraction on the dialogue content by the third agent to obtain key information, wherein the key information is used to optimize subsequent dialogues; or
performing an information clarification and reflection on the dialogue content by the third agent to obtain a dialogue reflection result.

8. The method of claim 7, further comprising:
determining the key information and the dialogue reflection result as an analysis result of the dialogue analysis agent;
obtaining first structured data by performing a structural processing on the analysis result of the dialogue analysis agent; and
determining the first structured data as shared data and storing the shared data in a data center, wherein the first structured data is accessible by at least one of the first agent or the one or more second agents.

9. The method of claim 6, wherein the third agent is a dialogue quality inspection agent, and performing the intelligent analysis on the dialogue content by the third agent comprises:
obtaining a quality inspection result by performing a hallucination monitoring and a compliance monitoring on the dialogue content by the third agent.

10. The method of claim 9, wherein after obtaining the quality inspection result, the method further comprises:
determining an abnormal dialogue content based on the quality inspection result, and collecting the abnormal dialogue content as sample data for an agent fine-tuning, wherein the sample data is used for a fine-tuning training of a relevant agent.

11. The method of claim 2, wherein determining the auxiliary information required for the one or more second agents comprises:
obtaining one or more target services corresponding to the one or more second agents; and
obtaining configuration information of the one or more target services corresponding to the one or more second agents, and obtaining the auxiliary information required for the one or more second agents from the configuration information.

12. The method of claim 1, wherein the first agent determining the one or more second agents from the set of agents based on the input information comprises:
obtaining a user profile and historical behavior data as auxiliary information for the first agent;
obtaining a set of intent information by performing an intent recognition on the input information based on the auxiliary information for the first agent by the first agent, wherein the set of intent information at least comprises one user intent; and
determining the one or more second agents from the set of agents based on the at least one user intent.

13. The method of claim 1, wherein before the first agent determines the one or more second agents from the set of agents based on the input information, the method further comprises:
determining a current target service scenario based on the input information;
obtaining an agent associated with the target service scenario; and
determining the set of agents corresponding to the target service scenario according to the agent associated with the target service scenario.

14. The method of claim 1, wherein before the first agent determines the one or more second agents from the set of agents based on the input information, the method further comprises:
obtaining an industry field to which an intelligent service belongs and an industry field of a user corresponding to the input information; and
obtaining the set of agents based on the industry field to which the intelligent service belongs and the industry field of the user corresponding to the input information.

15. The method of claim 1, the set of agents comprises at least one of: a script generation agent, a retrieval-augmented generation agent, a proactive dialogue agent, a dialogue-to-image generation agent, a dialogue-to-video generation agent, an image recognition agent or an information search agent.

16. An electronic device, comprising:
at least one processor; and
a memory communicatively connected to the at least one processor;
wherein the memory stores instructions executable by the at least one processor, and when the instructions are executed by the at least one processor, the at least one processor is caused to:
receive an information processing request, wherein the information processing request comprises input information;
input the input information to a first agent and obtain output information of the first agent, wherein the first agent determines one or more second agents from a set of agents based on the input information; and
obtain response information corresponding to the input information based on the output information of the first agent and the one or more second agents.

17. The electronic device of claim 16, wherein the at least one processor is further caused to:
determine auxiliary information required for the one or more second agents, wherein the auxiliary information comprises at least one of a preconfigured dialogue strategy, a user profile or a historical dialogue;
generate a prompt for the one or more second agents based on the auxiliary information and the output information of the first agent; and
obtain the response information corresponding to the input information based on the prompt for the one or more second agents.

18. The electronic device of claim 16, wherein the at least one processor is further caused to:
determine an execution sequence of the plurality of second agents and a dependency relationship between the plurality of second agents based on the output information of the first agent;
invoke the plurality of second agents according to the execution sequence, and determining input information of a currently invoked second agent based on the dependency relationship;
generate a prompt for the currently invoked second agent based on auxiliary information and a corresponding input information of a second agent; and
obtain second output information corresponding to the currently invoked second agent based on the prompt for the currently invoked second agent until all the second agents have been invoked according to the execution sequence, and obtaining the response information corresponding to the input information.

19. A non-transitory computer-readable storage medium, wherein the medium stores computer instructions, and the computer instructions are used to cause a computer to:
receive an information processing request, wherein the information processing request comprises input information;
input the input information to a first agent and obtain output information of the first agent, wherein the first agent determines one or more second agents from a set of agents based on the input information; and
obtain response information corresponding to the input information based on the output information of the first agent and the one or more second agents.

20. A computer program product comprising computer programs, wherein the computer programs, when executed by a processor, implement the method of claim 1.
